(19) United States
(12) Patent Application Publication
(10) Pub. No.: US 2005/0249992 A1
(43) Pub. Date: Nov. 10, 2005

(54) Power supply system and abnormal detection method for the power supply system

(75) Inventor: Hiroyasu Bitoh, Oume-shi (JP)

Correspondence Address: FRISHAUF, HOLTZ, GOODMAN & CHICK, PC, 220 5TH AVE FL 16, NEW YORK, NY, 10001-7708, US

(73) Assignee: Casio Computer Co., Ltd, Tokyo (JP)

(21) Appl. No.: 11/131,123

(22) Filed: May 16, 2005

Related U.S. Application Data
(63) Continuation of application No. PCT/JP03/14875, filed on Nov. 21, 2003.

(30) Foreign Application Priority Data
Nov. 26, 2002 (JP) 2002-342412

(51) Int. Cl. H01M 8/04; H01M 8/24

(52) U.S. Cl. 429/24; 429/26

(57) ABSTRACT

A power supply system for producing electric power comprising at least a power generation section for generating power comprises at least one chemical reaction section to which fuel for power generation is supplied; heating sections for heating the chemical reaction section; and comprises a temperature detection section for detecting the temperature of the chemical reaction section that comprises an abnormal judgment portion which judges abnormalities in the power supply system are occurring when discriminated that the temperature change of the chemical reaction section is not the proper variation quantity based on the heat of the heating sections.

This is a Continuation Application of PCT Application No. PCT/JP2003/014875 filed Nov. 21, 2003.

### TECHNICAL FIELD

This invention relates to a power supply system and an abnormal detection method for the power supply system, and more particularly comprises a power supply system equipped with a power generation section which generates predetermined electric power and comprises chemical reactors to which fuel for power generation is supplied. Furthermore, when abnormalities of damage or failure and the like in the chemical reactors of the power supply system have occurred, the present invention relates to an abnormal detection method which detects occurrences of those abnormalities.

### BACKGROUND ART

In recent years, there has been steadily increasing public interest in environmental problems and energy issues. As the power supply system which becomes more commonly used in the next generation, Research and Development (R&D) has trended toward the spread in utilization of around 30 to 40 percent of relatively high-octane fuel cells with generating efficiency (energy conversion efficiency) and have very little influence (environmental impact) on the environment.

As the field to which a power supply system using such a fuel cell is applied, for example, in the automobile field, research and development for applying the power supply system with a fuel cell for the power supply unit of such electric automobiles are explored vigorously, as well as being put into practical use and produced commercially. An electric automobile using an efficient electric motor as the drive unit is needed to replace the big gasoline engines and large diesel power plants, which have a significant negative environmental impact because of discharging poisonous exhaust gases and the like.

Additionally, conventional miniaturization of a power supply system using such a fuel cell to meet the demands of the times for high performance handcarry type electronic devices such as a Personal Digital Assistant (PDA) or a cellular/mobile phone driven by a secondary battery, a digital still camera, a digital video camcorder, a handheld television or a notebook personal computer and the like coupled with the need for a durable and affordable power supply to extend the operating time, R&D for making it possible to apply as a power supply unit which replaces a secondary battery in these portable devices has also been advanced rapidly in recent years.

Now, set to a power supply system using a fuel cell, is a configuration which comprises, for example, a chemical reactor which comprises a vaporizing section, a reforming section and a byproduct removing section; the fuel for power generation such as methanol and the like is vaporized by the vaporizing section; the fuel for power generation to hydrogen gas and the like is reformed with the reforming section, the carbon monoxide within the hydrogen gas refined is eradicated with the byproduct removing section; and next the hydrogen gas is generated and supplied to the fuel cell. As for these chemical reactors, in each chemical reactor in order for the desired chemical reaction to advance, for example, the reforming section is set to a configuration of around 300 degrees Centigrade (300° C.) (around 572 degrees Fahrenheit (572° F.)) so that it may become a comparatively elevated temperature.

For that reason, for example, the configuration comprises heaters for heating each chemical reactor so that it may heat to a predetermined temperature. Also, the configuration comprises a thermal insulation structure insulated from the periphery in order to prevent heat dissipation to the periphery and to reduce the loss of heat. This thermal insulation structure, for example, a vacuum insulation structure may be used which is formed in the above-mentioned reforming section and the like within a vacuum container of which the interior is vacuumed (isolated from external influences).

In this manner, for example, if the vacuum insulation structure is comprised as the thermal insulation structure in a reforming section and the like, when abnormal circumstances of the vacuum insulation structure having been damaged and the vacuum broken by some impact and the like occurred, heat spreads to the apparatus or device equipped with the power supply system and it will overheat, catch fire or pose a potential hazard to the user of the apparatus or device. In that case to prevent occurrences of overheating or fires in such an apparatus or device, it is necessary to detect all occurrences of abnormalities due to damage and the like of the thermal insulation structure in the chemical reactor to be able to administer suitable management.

### DISCLOSURE OF THE INVENTION

The present invention has been made in view of the circumstances mentioned above. Accordingly, a power supply system which is comprised with a chemical reaction section heated by predetermined temperature and produces electric power has advantages in that occurrence of abnormalities can be detected simply when an abnormality of the power supply system by damage and the like have occurred, without merely using the sensor for exclusive use for abnormal detection; the system can be minimized; and overall cost can be reduced.

In order to acquire the above-mentioned advantages in the present invention, the power supply system comprises a power generation section which generates the electric power comprises at least one chemical reaction section to which the fuel for power generation at least is supplied and heating sections which heat the chemical reaction section and generates electric power; a temperature detection section which detects the temperature of the chemical reaction section; and a power generation control section comprising an abnormal judgment portion which judges whether or not abnormalities in the power supply system are occurring at least based on the temperature of the chemical reaction section detected by the temperature detection section.

The above-mentioned power generation control section further comprises a temperature change detection portion which detects the temporal response of the temperature of the chemical reaction section based on detection of the temperature of the chemical reaction section by the temperature detection section, and the temperature change discrimination portion which determines whether or not the temperature change detected by the temperature change detection portion is the proper variation quantity; the abnormal judgment portion judges abnormalities in the power supply system are occurring when the quantity of temperature change is determined as not the proper variation quantity by the temperature change discrimination portion; the power generation section comprises a fuel cell which generates the electric power by electrochemical reaction using a specified fuel element including hydrogen fuel for the power generation; the chemical reaction section comprises at least a plurality of chemical reactors including the fuel vaporizing section which vaporizes the fuel for power generation and a fuel reforming section which produces the specified fuel element from the vaporized fuel for power generation, and comprises vacuum insulation and the like thermal insulation structure.

Additionally, the above mentioned power generation control section further comprises a timer which times the heating elapsed time from the heating startup time of the chemical reaction section by the heating sections; the temperature change discrimination portion which detects the temperature of the chemical reaction section at startup time when the heating elapsed time of the timer becomes the predetermined regulated startup time by the temperature detection section; and the power supply measurement portion which measures the power supply quantity supplied to the heating sections as the power supply quantity at startup time when the heating elapsed time according to the timer becomes the predetermined regulated startup time, compares the power supply quantity at startup time with the reference power supply quantity supplied to the heating sections, and discriminates the relative difference by comparing the temperature at startup time with the predetermined regulated startup temperature; the abnormal judgment portion judges abnormalities are occurring in the power supply system when the temperature is discriminated at the startup temperature as lower than the regulated startup temperature by the temperature change discrimination portion, and the power supply quantity at the startup time is discriminated as equal to or greater than the reference power supply quantity by the power supply quantity discrimination portion or judges abnormalities in the power supply system are occurring when discrimination is greater than that.

The above-mentioned power generation control section further comprises the temperature change discrimination portion which detects the temporal response of the temperature of the chemical reaction section as a temperature change at the time of the operation based on detection of the temperature of the chemical reaction section by the temperature detection section at operation time of the power generation section, compares the temperature change at operation time with the temperature change tolerance level at predetermined operation time, and discriminates whether or not the temperature change tolerance level at that operation time deviated; a portion which compares the power supply supplied to the heating sections with the reference power supply at startup time while detecting the temperature change at the operation time; a fuel supply quantity discrimination portion which detects the fuel supply quantity for power generation supplied to the power generation section, compares the supply quantity of that fuel for power generation with the predetermined fuel supply quantity tolerance level, and discriminates whether or not from that fuel supply quantity tolerance level deviated, the abnormal judgment portion judges abnormalities are occurring in the power supply system when a temperature change is in the temperature change tolerance level and also the power supply supplied to the heating sections at the time of temperature change detection at the time of operation exceeds the reference power supply at the time of operation discriminated by the temperature change discrimination portion, the fuel supply quantity of the fuel for the power generation is in the fuel supply quantity tolerance level discriminated by the fuel supply discrimination portion, and the power supply is within the power supply tolerance level discriminated by the power supply discrimination.

The above-mentioned power generation control section further comprises a portion to suspend heating of the chemical reaction section by the heating sections when judged abnormalities are occurring to the power supply system by the abnormal judgment portion, and a portion to suspend the feed of the above-mentioned fuel for power generation to the chemical reaction section by the fuel supply section for power generation.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is an outline block diagram showing an example of the internal configuration of an electronic device by which the power supply system related to this invention is applied.

FIG. 2 is a block diagram showing the first embodiment of the power supply system concerning the present invention.

FIG. 3 is a transmission plan showing an example of the configuration applicable to the reforming section of the chemical reaction section in the embodiment.

FIG. 4 is a sectional drawing in the B-B surface of the reforming section in FIG. 3.

FIG. 5 is the same sectional drawing as FIG. 4 in another example of the configuration applicable to the reforming section of the chemical reaction section in the embodiment.

FIG. 6 is an outline block diagram showing an example of one configuration of the fuel cell applicable to the power generation section related to the embodiment.

FIG. 7 is a flowchart which shows the operation of the abnormal detection process at startup time of the power supply system.

FIG. 8 is a flowchart which shows operation of the abnormal detection process at operation time of the power supply system.

FIG. 9 is a block diagram showing the second embodiment of the power supply system related to the invention.

### BEST MODE FOR CARRYING OUT THE INVENTION

The present invention is to provide a power supply system and an abnormal detection method for the power supply system which will hereinafter be described in detail with reference to the preferred embodiments shown in the accompanying drawings.

<<The Equipment Applied to the Power Supply System>>

Initially, an example equipment configuration is applied to the power supply system concerning this invention will be explained.

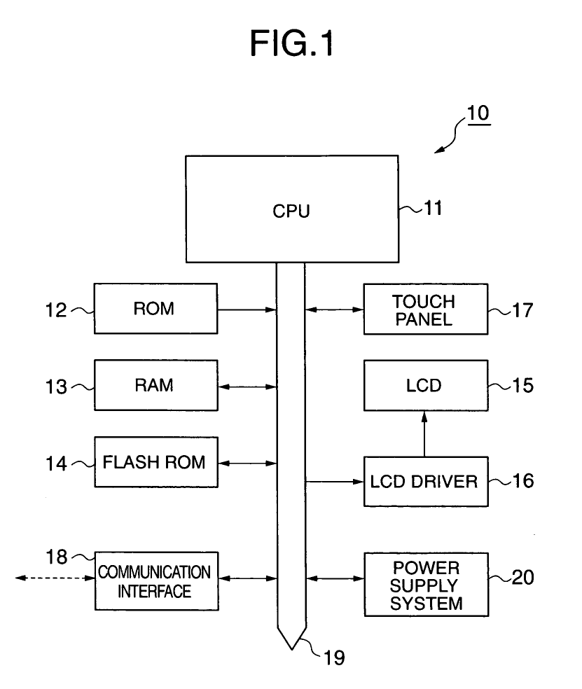

FIG. 1 is an outline block diagram showing an example of the internal configuration of an electronic device by which the power supply system related to this invention is applied.

The invention relates to a power supply system is applied as a portable electronic device, such as a Personal Digital Assistant, a cellular/mobile phone, a digital still camera, a digital video camcorder, a handheld television, a notebook personal computer and the like. As shown in FIG. 1, the power supply system related to the present invention is applied to electronic device in the case example of a portable handheld Personal Digital Assistant (hereinafter referred to as PDA).

Additionally, although the power supply system concerning this invention is applied to an electronic device, such as a PDA and the like, and explained here, the power supply system related to the present invention only illustrates an example device. Irrespective of this, as an example, the power supply unit can also be suitably applied to an electric vehicle and the like.

As shown in FIG. 1, the power supply system related to this invention is applied to an electronic device 10, for example, comprises a Central Processing Unit (CPU) 11 which performs central control of each section; a Read-Only Memory (ROM) 12 which reads and memorizes usable information, a Random Access Memory (RAM) 13 which stores information temporarily; a non-volatile Flash Read-Only Memory (Flash ROM) 14 which memorizes usable Read/Write (R/W) information; a Liquid Crystal Display (LCD) 15 which performs screen display of the display information; an LCD driver 16 which performs screen display control of the LCD 15 by a display control signal transmitted from CPU 11; a touch panel 17 which transmits input information entered by the touch operation on a user's LCD 15 to the CPU 11; a communication interface 18 (here in after referred to as I/F) which controls communication with external equipment by infrared data communication (IrDA); connector communication, wireless Local Area Network (LAN) transmission method, and the like; a power supply system 20 which is the power supply of the electronic device 10 is equipped with a fuel cell and generates predetermined electric power; and each section except for the LCD 15 are connected by a bus 19.

The CPU 11, for example, reads an application program specified from among the system programs stored within the ROM 12 or the Flash ROM 14 and various application programs, and extracts them in the RAM 13.

In addition, the CPU 11 temporarily stores various data within the RAM 13 in response to various directions input from the touch panel 17 or that which performs various processes according to the above-mentioned extracted application programs using these input directions and input data; and stores the processing result in the RAM 13 and displayed on the LCD 15.

Additionally, the CPU 11 transmits to the power supply system 20 an indication signal for directing the power generation operation of the power supply system 20, and a load drive state signal which indicates the details of the drive state of the electronic device 10.

Also, the CPU 11 receives from the power supply system 20 a signal which indicates the details of the power generation state of the power supply system 20, described later, and a signal which indicates abnormalities by thermal insulation damage to the power supply system 20 that have purportedly occurred.

Furthermore, the programs, data and the like memorized in ROM 12 and Flash ROM 14 can be set to a configuration which receives and stores part or all of these via a communication network and the I/F 18 from external equipment.

Although, the LCD 15 performs the screen display using a liquid crystal display method, this invention is not limited to this and can be substituted with an electroluminescent (EL) display (also referred to as ELD) and the like. The above-mentioned configuration illustrated a typical configuration example in the electronic device. Needless to say, the present invention may have other configurations.

<<The First Embodiment of the Power Supply System>>

Next, the first embodiment of the power supply system related to this invention will be explained.

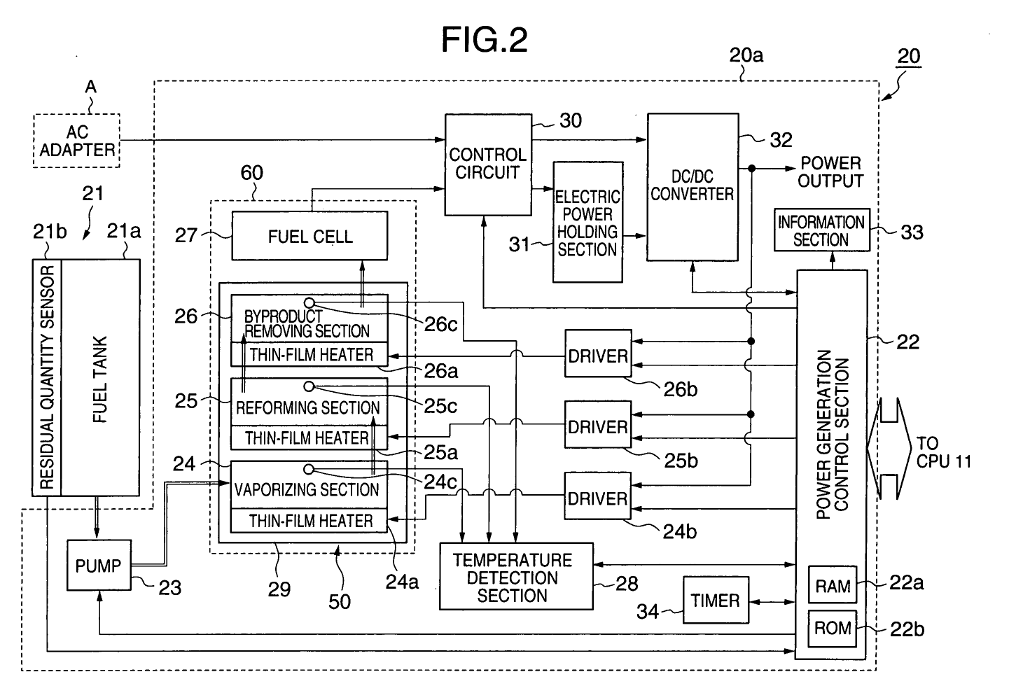

FIG. 2 is a block diagram showing the first embodiment of the power supply system concerning the present invention.

The embodiment related to the power supply system 20, as shown in FIG. 2, comprises divided sections equipped with a power generation module 20a and a fuel cartridge 21. The power generation module 20a generates predetermined electric power (electrical energy) based on the fuel for power generation supplied from the fuel cartridge 21. The fuel for power generation is enclosed in the detachable fuel cartridge 21, and the fuel cartridge 21 is joined with the main power generation module 20a.

Hereinafter, each component of the configuration will be explained in detail.

<<Fuel Cartridge>>

The fuel cartridge 21 is equipped with a fuel tank 21a consisting of a sealed high-octane fuel container enclosed and filled with fuel for power generation constituted from liquid fuel or liquefaction fuel containing hydrogen, and joined with the power generation module 20a.

Also, the fuel cartridge 21 can be further equipped with a residual quantity sensor 21b which detects residual quantity of the fuel for power generation in the fuel tank 21a.

Furthermore, the power generation module 20a comprises a fuel supply section 23 for supplying fuel for power generation controlled by the power generation control section 22. In order for the quantity necessary by a fuel cell 27 to produce electric power of predetermined voltage, fuel for power generation in the fuel tank 21a is supplied to a vaporizing section 24 as needed via the fuel supply section 23.

Here, the fuel for power generation employed in the power supply system, for example, although a mixed solution of methanol and water is used it is not limited to this. Methanol substitution with a liquid fuel type alcohol system, such as ethanol, butanol and the like; or dimethyl ether or isobutane which are gas at ambient temperature and ambient pressure; or a liquefaction fuel made up of hydrocarbon gas and the like are applicable.

Also, the fuel tank 21a, for example, is provided with a control valve so the feed of fuel for power generation enclosed in the fuel tank 21a only becomes available in the state where it is joined with the power generation module 20a. Accordingly, the fuel cartridge 21 in the state where it is disjoined from the power generation module 20a, the fuel for power generation does not leak to the outside of the fuel cartridge 21.

The residual quantity sensor 21b in the fuel cartridge 21, for example, comprises a group of conductors made up of almost rod-shape conductors arranged in predetermined positions in the fuel tank 21a. The electric resistance value between these conductors is measured and the residual quantity of the fuel for power generation enclosed in the fuel cartridge 21 is detected. Although these conductors, for example, are provided with a good conductor, such as carbon and the like, it is as effective as being formed in the inner circumference of the fuel tank 21a with a printed pattern formed from gold and the like for example.

The power generation control section 22 has a built-in resistance measurement circuit which measures the electric resistance value between the conductors of the residual quantity sensor 21b. The residual quantity of fuel for power generation is computed based on the measured electric resistance value.

The residual quantity sensor 21b is not limited to such a resistance level method, and other sensors such as an optical sensor method, a fiber sensor method using optical fibers, an ultrasonic method, and the like which measure variations of the reflective time period of an ultrasonic wave can be employed. Also, the fuel cartridge 21 configuration is not limited to being a detachable type as it can be suitably formed in the power generation module 20a and as one unit.

<<Power Generation Module>>

The power generation module 20a, as shown in FIG. 2, mainly comprises the pump (fuel supply section) 23, a power generation section 60, a chemical reaction section 50, the fuel cell 27, an electric power holding section 31, a control circuit 30, the power generation control section 22, a DC-to-DC (DC/DC) converter 32, an information section 33 and a timer 34. The pump 23 (fuel supply section for power generation) performs delivery or stoppage of the fuel for power generation supplied from the fuel cartridge 21 in response to a control signal of the power generation control section 22. A power generation section 60 generates predetermined electric power based on the fuel for power generation supplied via the pump 23 from the fuel cartridge 21, which includes the chemical reaction section 50 and the fuel cell 27 provided with a thermal insulation structure. The electric power holding section 31 once holds the electric power produced in the power generation section 60. The control circuit 30 controls the charging of the electric power holding section 31 and the power supply feed to the load based on a control signal from the power generation control section 22. The power supply system 20 is provided with the DC-to-DC (DC/DC) converter 32 which outputs a power supply indication signal to the power generation control section 22 and supplies as the load of each of the configuration sections of the electronic device 10. For example, the electric power output from the power generation section 60 and the electric power holding section 31 is changed to direct current (DC) based on a control signal from the power generation control section 22. The power generation control section 22 transmits the status of the power generation module 20a to the CPU 11 while controlling each section of the power generation module 20a in response to indication signals received and the communicative action with the CPU 11. For example, in the information section 33, when detected abnormalities such as thermal insulation damage and the like in the chemical reaction section 50 occur, the problem in the form of a light, sound and the like is reported to the user. The timer 34 (timing device) counts the elapsed time from the startup operation of the power generation section 60 and outputs to the power generation control section 22 an elapsed time signal.

The chemical reaction section 50 comprises a plurality of chemical reactors which includes the vaporizing section 24, a reforming section 25 and a byproduct removing section 26 (carbon monoxide (CO) and other residue). The vaporizing section 24 vaporizes the fuel for power generation delivered from the pump 23. The reforming section 25 performs reforming of the fuel for power generation vaporized by the vaporizing section 24 to fuel the fuel cell 27. The by product removing section 26 removes carbon monoxide that occurred in the fuel during reforming by the reforming section 25.

Additionally, the chemical reaction section 50 further comprises the thin-film heaters 24a, 25a, 26a; the temperature sensors 24c, 25c, 26c; a temperature detection section 28 and a thermal insulation container 29. The thin-film heaters (heating sections) 24a, 25a, 26a are provided in each of the chemical reactors of the vaporizing section 24, the reforming section 25 and the byproduct removing section 26; which heat each of the chemical reactors. The temperature sensors 24c, 25c, 26c (temperature detection section) detect and output the temperature of each of the chemical reactors of the vaporizing section 24, the reforming section 25 and the byproduct removing section 26. The temperature detection section 28 outputs the temperature information output from the temperature sensors 24c, 25c, 26c to the power generation control section 22 and the thermal insulation container 29 insulates the vaporizing section 24, the reforming section 25, the byproduct removing section 26, and the thin-film heaters 24a, 25a, 26a.

The power generation module 20a further comprises the drivers 24b, 25b, 26b; RAM 22a and ROM 22b. The drivers 24b, 25b, 26b supply the electric power for driving the thin-film heaters 24a, 25a, 26a based on a control signal from the power generation control section 22 using a portion of the electric power generated by the power generation section 60. The power generation control section 22 has built-in RAM 22a and ROM 22b.

Furthermore, the power supply system 20, for example, when an AC adapter A is connected to an AC power supply for domestic use and configured with a usable connection to the AC adapter A which changes alternating current into predetermined direct current, the control circuit 30 is substituted with the fuel cell 27 and supplies direct current output from the AC adapter A to the electric power holding section 31 and the DC/DC converter 32, and supplied to the load.

<<Chemical Reaction Section>>

The chemical reaction section 50 is provided with chemical reactors in the vaporizing section 24, the reforming section 25 and the byproduct removing section 26 in a configuration using, for example, methanol (CH₃OH) and water (H₂O) as the fuel for power generation so that hydrogen gas (H₂) for the fuel cell 27 can be produced from the fuel for power generation.

The vaporizing section 24 heats and vaporizes the fuel for power generation supplied from the fuel cartridge 21 by the thin-film heater 24a through a vaporization process.

The reforming section 25 transforms the fuel for power generation vaporized by the vaporizing section 24 into mixed gases of hydrogen (H₂) and byproduct carbon dioxide (CO₂) through a steam reforming reaction process.

The byproduct removing section 26 transforms the carbon monoxide gas (CO) included as a residual byproduct of trace (very small) quantity in the mixed gases transformed by the reforming section 25 into carbon dioxide gas, and removes it.

Also, the fuel cell 27 produces the power supply to the load DVC and the operating power of each section of the power generation module 20a with a high concentration of hydrogen gas produced in the reforming section 25 and the byproduct removing section 26.

In more detail, the vaporizing section 24 which makes the methanol and water vaporize by the thin-film heater 24a, controlled by the driver 24b, is set up to the atmospheric temperature condition of around the boiling point in general of methanol and water, which is the fuel for power generation supplied via the pump 23 from the fuel cartridge 21, and the derivative to the reforming section 25.

Additionally, the vaporizing section 24 and thin-film heater 24a are provided in the thermal insulation container 29 have a thermal insulation structure to prevent a decline in heat efficiency, and heat from the thin-film heater 24a radiates to the periphery as described later.

The reforming section 25 transforms into hydrogen gas (H₂) the fuel for power generation, which is introduced and vaporized by the vaporizing section 24 from the fuel cell 27. Specifically, the thin-film heater 25a controlled from the driver 25b with the to methanol and water introduced and vaporized as mentioned above, by setting the atmospheric temperature condition of 300 degrees Centigrade (300° C.) in general (around 572 degrees Fahrenheit (572° F.)), the hydrogen and carbon dioxide transform into mixed gases by the chemical reaction shown in the following formula (1):
CH₃OH+H₂O→3H₂+CO₂ (1)

Subsequently, the byproduct removing section 26 removes the carbon monoxide that is poisonous to the human body in the byproducts of trace quantity contained in the mixed gases, which include hydrogen and carbon dioxide as the main ingredients produced with the reforming section 25. By setting the thin-film heater 26a controlled by the driver 26b to a predetermined atmospheric temperature condition, this residual carbon monoxide gas transforms into a hydrogen and carbon dioxide gas mixture by the chemical reaction shown in following formula (2):

Additionally, inside the byproduct removing section 26 well-known catalysts Platinum Pt, Alumina Al₂O₃ (aluminum oxide) and the like are carried for advancing most efficiently the chemical reaction shown in formula (2):
CO+H₂O→H₂+CO₂ (2)

Since the chemical reaction shown in formula (2) is an exothermic reaction (also known as an exothermal reaction), the configuration is designed for the heat produced in the byproduct removing section 26 to be also conducted in the reforming section 25.

Moreover, the byproduct removing section 26 and the thin-film heater 26a as well are shielded with the thermal insulation container 29 to prevent a decline in the heat efficiency of the heat radiating to the periphery and insulated from ambient air. In addition, the byproduct removing section 26 is also effective as a heat dissipation portion for discharging this reaction heat.

Furthermore, the chemical reaction as illustrated in formula (2) requires water (H₂O). Although reaction water remained with the reforming section 25 which is allocated in the water supplied as fuel for power generation from the fuel cartridge 21, when this water is of insufficient quantity relative to the carbon monoxide gas within the mixed gases, a structure which supplies the deficient water portion can be attached to the byproduct removing section 26.

Also, the byproduct removing section 26 transforms carbon monoxide into carbon dioxide gas by the chemical reaction shown in formula (3). Accordingly, the carbon monoxide gas which is not eradicated in the combustion of the chemical reaction shown in formula (2) can be removed from the above-mentioned mixed gases, and the concentration of the carbon monoxide gas within the above-mentioned mixed gases can be reduced to a level which does not negatively influence or endanger the human body.
2CO+O₂→2CO₂ (3)

Moreover, within the byproduct removing section 26 a well-known catalyst for oxidizing by chemical reaction is carried and only carbon monoxide gas is selectively shown in formula (3), without consuming the hydrogen gas contained in the mixed gases introduced from the reforming section 25.

Subsequently, the configuration of each chemical reactor will be explained in detail.

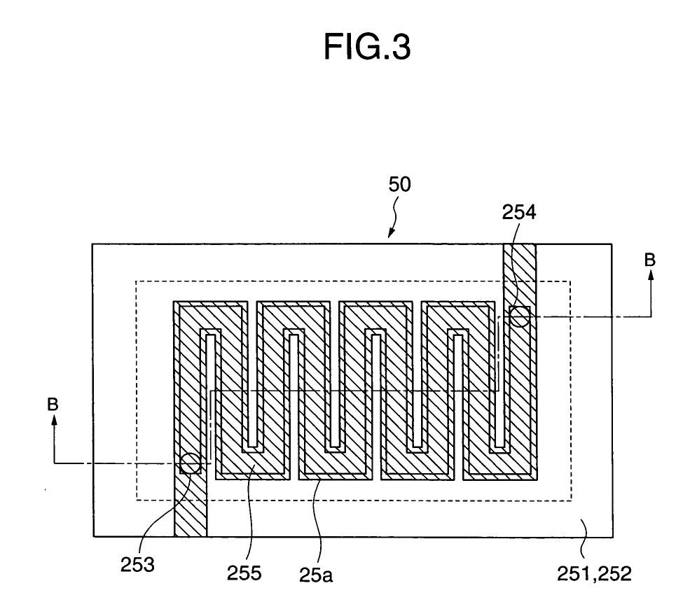

FIG. 3 is a transmission plan showing an example of the configuration applicable to the reforming section of the chemical reaction section in the embodiment.

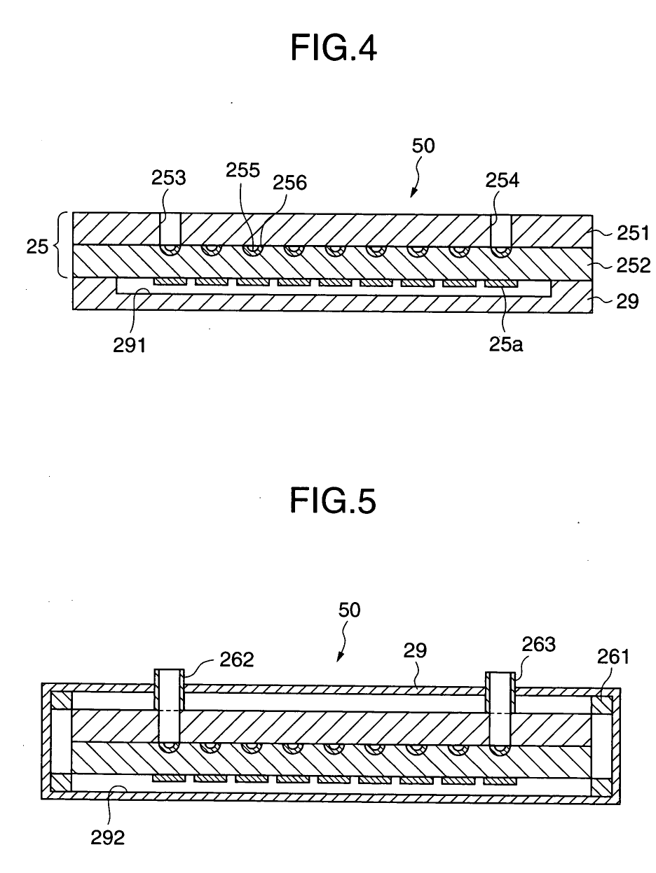

FIG. 4 is a sectional drawing in the B-B surface of the reforming section in FIG. 3.

FIG. 5 is the same sectional drawing as FIG. 4 in another example of the configuration applicable to the reforming section of the chemical reaction section in the embodiment.

Each of the chemical reactors in the chemical reaction section 50 in this embodiment are provided from micro-reactors, for example, each configuration has a substrate comprised of a silicon substrate and has a passage provided of micro-fabrication on that substrate.

These micro-reactors consist of a configuration, for example, when applied to the reforming section 25 in this embodiment, as shown in FIGS. 3 and 4, whereby the mixed gas of methanol and water flowed in the passage is reformed and configured so that mixed gases of hydrogen and carbon dioxide are discharged. Each micro-reactor comprises a feed port 253; substrates 251, 252 (for example, silicon substrate); a discharge vent 254; a passage 255; and a reaction catalyst layer 256. The feed port 253 introduces the mixed gas of methanol and water in between the substrates 251, 252. The discharge vent 254 discharges the resultant mixed gases hydrogen and carbon dioxide. The passage 255 which zigzags (meanders) is provided in between the feed port 253 and the discharge vent 254. The reaction catalyst layer 256 is carried in part at least on the inner wall surface of the passage 255. Here, the passage 255 cross-sectional and horizontal overall length intersects at right angles to each other in the direction of movement (traveling direction), for example, each has a dimension of less than 500 micrometers (500 μm) micro-fabrication. Also, the passage 255 zigzags to enlarge the reaction area of the reaction catalyst layer 256 with the mixed gas methanol and water. Furthermore, the catalyst layer consists of a well-known Copper (Cu), Zinc oxide (ZnO), Alumina (Al₂O₃) and the like based catalysts for advancing efficiently the chemical reaction shown in formula (1).

Since the chemical reaction shown in formula (1) is an endothermic reaction (also referred to as endothermal reaction which absorbs heat), in order for the reforming section 25 to advance most efficiently this reaction, the thin-film heater 25a is provided along the passage 255. Also, the thin-film heater 25a can be a configuration formed in the entire surface of the substrate 252.

In addition, the chemical reactor in this embodiment has a thermal insulation structure of vacuum insulation and the like to elevate heat efficiency in heating of the passage. The thermal insulation container 29 encloses (covers) the thin-film heater 25a. This shielding is constructed so the thin-film heater 25a is thermally insulated from ambient air, and configured so that it restrains (controls) the heat by the thin-film heater 25a radiating to the periphery. The thermal insulation container 29 has a hollow section 291 which surrounds the thin-film heater 25a. This hollow section 291 can realize a thermal insulation capability by enclosing gas, such as air, Freon, carbon dioxide gas or by making the hollow section 291 into an almost vacuum.

Furthermore, shown in FIG. 5 is another feasible configuration applicable to the chemical reactor in this embodiment. While provided with a micro-reactor consisting of the substrates 251, 252 and the thin-film heater 25a which are the same as shown in FIG. 4 mentioned above, the structure can be set to the thermal insulation container 29 in a form surrounding (encircling) entirely the substrates 251, 252. In this case, the substrates 251, 252 are mounted via a support medium 261 inside the thermal insulation container 29. In addition, for example, the support medium 261 is provided in the upper and lower four corners of the substrates 251, 252. Moreover, the feed port 253 and the discharge vent 254 of the substrate 251 are provided with a feed port withdrawal tube 262 of and a discharge vent withdrawal tube 263 for drawing out to the outside of the thermal insulation container 29. Accordingly, in between the thermal insulation container 29 and the substrates 251, 252, a hollow section 292 is formed, except for the section of the support medium 261. The substrates 251, 252 and thin-film heater 25a are entirely insulated from ambient air, and insulation efficiency can be further improved. Besides, the hollow section 292 which surrounds gas, such as air, Freon, carbon dioxide gas, or creates an almost vacuum is the same as the embodiment mentioned above.

Also, although explained in the case applied to the reforming section 25 mentioned above, in the vaporizing section 24 and byproduct removing section 26 of the other chemical reactors, the same structure is applicable.

Moreover, the thermal insulation container 29, entirely encloses each chemical reactor of the vaporizing section 24, the reforming section 25 and the byproduct removing section 26, thereby it can be formed as a unit in one body.

<<Fuel Cell>>

<<Fuel Cell>>

The fuel cell 27 comprises a solid macromolecule type fuel cell body.

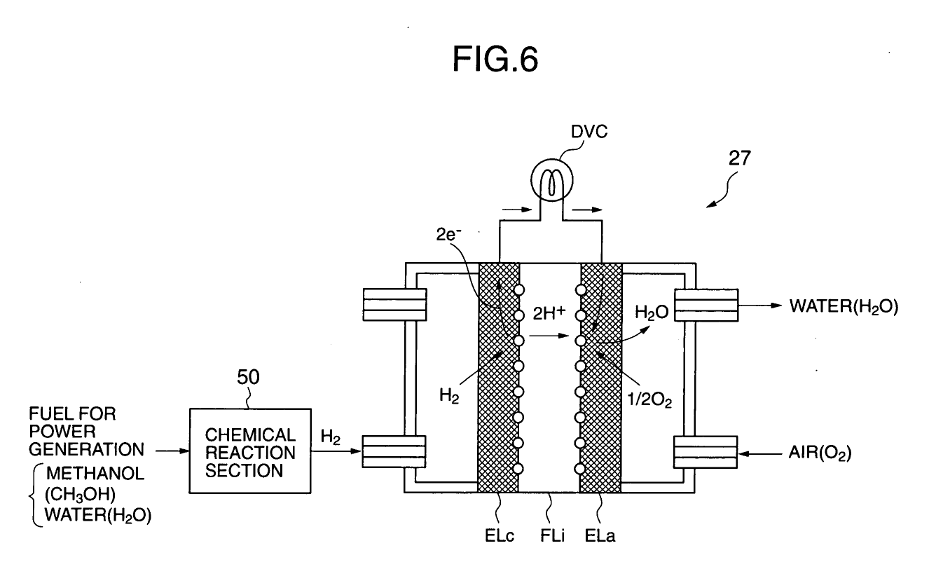

FIG. 6 is an outline block diagram showing an example of one configuration of the fuel cell applicable to the power generation section related to the embodiment.

As shown in FIG. 6, briefly, the fuel cell 27 comprises an ion conductive film membrane FLi, an air electrode ELa, and a fuel electrode ELc. The ion conductive film membrane (ion exchange membrane) FLi is interposed in between the air electrode ELa (anode—positively charged) and the fuel electrode ELc (cathode—negatively charged). The air electrode ELa consists of a carbon electrode to which catalyst particulates of platinum and the like are adhered. The fuel electrode ELc consists of a carbon electrode to which catalyst particulates of platinum or platinum-ruthenium are adhered. Additionally, the fuel electrode ELc is supplied hydrogen gas (H₂) extracted from the fuel for power generation by the above-mentioned chemical reaction section 50. On the other hand, the air electrode ELa is supplied with oxygen gas (O₂) within the air. Accordingly, power generation is performed by an electromechanical reaction shown below and electric power is generated.

Specifically, by supplying hydrogen gas (H₂) to the fuel electrode ELc, as shown in the following reaction formula (4), the hydrogen ion (proton; H⁺) with the single electron (e⁻) separated as the above-mentioned catalyst occurs and then passes to the air electrode ELa side via the ion conductive film membrane FLi. The electron (e⁻) is taken out by the carbon electrode configuration of the fuel electrode ELc, thereby electric power is produced and the load DVC is supplied.
3H₂→6H⁺6e⁻ (4)

Meanwhile, by supplying oxygen gas (O₂) within the air to the air electrode ELa, as shown in the following reaction formula (5), the hydrogen ion (H⁺) and oxygen gas (O₂) within the air passed to the ion conductive film membrane FLi and the electron (e⁻) went via the load DVC to the above-mentioned catalyst, thus the air reacts and water (H₂O) is produced.
6H⁺+(3/2)O₂+6e⁻→3H₂O (5)

Such a series of electromechanical reactions (chemical reaction formulas (4) and (5)) advance under a low-temperature environment comparatively at around room temperature ˜80 degrees Centigrade (room temperature ˜80° C.)(room temperature ˜176 degrees Fahrenheit (176° F.)) and byproducts of other than electric power become only water (H₂O) basically.

In addition, the power supply drive (voltage/current) supplied to the load DVC by the electromechanical reaction method (formulas (4) and (5)) mentioned above, depends on the quantity of hydrogen gas supplied to the fuel electrode of the fuel cell 27. Therefore, the electrical energy of the electric power (generation of electric power) produced by the fuel cell 27 can be regulated arbitrarily by the power generation control section 22 controlling the pump 23, and controlling the quantity of hydrogen gas supplied to the fuel electrode.

Thus, initially the fuel for power generation is supplied to the vaporizing section 24 via the pump 23 from the fuel cartridge 21, then vaporized by the vaporizing section 24, and transformed into a mixed gas of hydrogen and carbon dioxide by the reforming section 25. Next, the carbon monoxide gas contained in this mixed gas as a very small quantity of impurity is then eradicated and transformed into carbon dioxide gas by the byproduct removing section 26, and lastly supplied to the fuel cell 27 as a high concentration of hydrogen gas.

<<Electric Power Holding Section>>

The control circuit 30 controls the output destination of the electric power supplied from the fuel cell 27 based on a charge control signal from the power generation control section 22, charges the electric power holding section 31 and performs output to DC/DC converter 32. The electric power holding section 31 becomes the main power supply instead of the fuel cell 27 at startup time of the electronic device 10.

In particular, when a power supply “ON” operation of the electronic device 10 is accomplished (i.e. the device is switched “ON”), the electric power accumulated in the electric power holding section 31 is output to the drivers 24b, 25b, 26b via the DC/DC converter 32. Also, electric power to the thin-film heaters 24a, 25a, 26a is supplied and heated. Each of the chemical reactors is set as a predetermined temperature. The fuel cell 27 commences power generation by introducing the fuel for power generation from the pump 23 into the vaporizing section 24. After the power generation startup, the power generation control section 22, after performing full charging of the electric power holding section 31, switches the power output point of the control circuit 30 to the DC/DC converter 32 from the electric power holding section 31. Furthermore, control of the fuel injection quantity of fuel for power generation supplied from the pump 23 by the power generation control section 22 is initiated after being heated sufficiently for provision of power generation by the thin-film heaters 24a, 25a, 26a.

Additionally, during power generation of the fuel cell 27 for example, the control circuit 30 always controls the electric power holding section 31 so that it remains fully charged. Also, when a power supply “OFF” operation is accomplished (i.e. the device is switched “OFF”) and full charging of the electric power holding section 31 is not performed, the control circuit 30 suspends (stops) the power supply system 20 after performing full charging of the electric power holding section 31.

<<Information Section>>

The information section 33, for example, comprises at least one luminescence portion, such as Light Emitting Diodes (LEDs) and the like; a display portion which has a display panel, such as a Liquid Crystal Display (LCD), electroluminescent (EL) display and the like; an audio output portion, such as a speaker and the like; and from within an oscillating generation portion, such as vibrator and the like.

The information section 33, when equipped with a display portion for example, digital display of the residual quantity of the fuel for power generation computed by the power generation control section 22; rate (percentage) relative to volume of the fuel tank 21a; and/or a gradual five-level display and the like can be performed.

Again similarly, set to the abnormal detection process at startup time and abnormal detection process at balance (equalization) time, a message indicator of the purported abnormal detection and the like of thermal insulation damage and the like can be performed as described later.

When the information section 33 comprises an audio output portion and the display details by the display portion mentioned above can be made into a message and performs an audio output.

<<Power Generation>>

Next, the functions of the power generation control section 22 will be explained.

At startup time of the power supply system 20, accompanying the startup of the electronic device 10 (load), the electric power accumulated in the electric power holding section 31 is supplied to the drivers 24b, 25b, 26b. In this startup operation, the power generation control section 22 enters a temperature measurement signal of the temperature detected in the temperature sensors 24c, 25c, 26c from the temperature detection section 28. The power generation control section 22 outputs to the drivers 24b, 25b, 26b a temperature control signal based on the temperature measurement signal and performs temperature control of the thin-film heaters 24a, 25a, 26a.

The power generation control section 22 outputs a fuel supply control signal to the pump 23 and concurrently performs temperature control of the thin-film heaters 24a, 25a, 26a; controls delivery and stoppage of the fuel for power generation to the vaporizing section 24 from the fuel cartridge 21 by controlling the operation (feed operation, suspension operation) of the pump 23; and regulates electric power generation of the fuel cell 27 by controlling the quantity of fuel supplied for power generation.

Specifically, the power generation control section 22 initially each of the chemical reactors of the vaporizing section 24, the reforming section 25 and the byproduct removing section 26, along with the fuel cell 27 are in a non-operational state. When a command signal activates the load received from the CPU 11, this initiates operation of each chemical reactor of the vaporizing section 24, the reforming section 25 and the byproduct removing section 26, along with the fuel cell 27; initiates feed of the fuel for power generation to the vaporizing section 24; initiates operation of the fuel supply of the pump 23 and temperature control of the thin-film heaters 24a, 25a, 26a. Additionally, the power generation control section 22 comprises a function (power supply measurement portion) which measures the electric energy (power supply quantity at startup time) supplied to each thin-film heaters by the time the electric power (power supply) and each chemical reactor become the predetermined startup state and supplied to each of the thin-film heaters in connection with the temperature control of the thin-film heaters 24a, 25a, 26a at startup time mentioned above.

Additionally, the power generation control section 22, then operates the vaporizing section 24, the reforming section 25, the byproduct removing section 26 and the fuel cell 27 and electric power generation is produced, as well as receives a load drive state signal which indicates the details of the load drive state at the operation time which drives the load from the CPU 11. Also, the power generation control section 22 inputs a power supply signal which indicates the power supply from the DC/DC converter 32. The power generation control section 22 outputs a fuel supply control signal to the pump 23 based on the received load drive state signal and the inputted power supply signal, thus controlling the feed operation of the pump 23 as well as regulate the electric power generation of the fuel cell 27. The power generation control section 22 performs temperature control of the thin-film heaters 24a, 25a, 26a based on the received load drive state signal and the inputted power supply signal concurrently with the feed operation control of the pump 23. In this manner, the power generation control section performs control of power generation by the fuel cell 27.

Moreover, the power generation control section 22 comprises the function (power supply measurement portion) which measures on every predetermined time interval, for example, the electric power (power supply) supplied to each of the thin-film heaters in connection with the temperature control of the thin-film heaters 24a, 25a, 26a at operation time mentioned above.

In addition, the power generation control section 22 outputs a charge control signal to the control circuit 30 and controls whether the electric power output destination supplied from the fuel cell 27 is to charge the electric power holding section 31 or used as the DC/DC converter 32. Furthermore, the power generation control section 22 inputs a signal which indicates the power supply outputted from the DC/DC converter 32 and outputs a conversion control signal to the DC/DC converter 32 based on the received power supply. The DC/DC converter 32 transforms the sum total of electric power of the power generation from the fuel cell 27 or the discharge from the electric power holding section 31 into direct current suitable to the load based on the conversion control signal.

For example, the power generation control section 22 when the load drive state signal received from the CPU 11 indicates that a large power supply (a heavy load) is required of the electronic device 10 outputs a conversion control signal to DC/DC converter 32 so that the electric power which is accumulated (stored up) in the electric power holding section 31 in addition to the electric power of the fuel cell 27 is also made to output.

Additionally, in the state of driving the vaporizing section 24, the reforming section 25, the byproduct removing section 26 and the fuel cell 27, the power generation control section 22 inputs a resistance signal from the residual quantity sensor 21b, and calculates the residual quantity of the fuel for power generation in the fuel tank 21a from the resistance signal. The power generation control section 22 transmits the residual quantity of the computed fuel for power generation to CPU 11. Also, when there is little remaining residual quantity, the power generation control section makes a status report to the information section 33.

Moreover, the ROM 22b memorizes (stores) a discrimination reference value for abnormal discrimination in the abnormal detection process at startup time and the abnormal detection process at operation time described later for each of the vaporizing section 24, the reforming section 25 and the byproduct removing section 26. Specifically, for example, the regulated startup time indicates the time period allowed value required at startup until it attains the regulated startup temperature from initiation of the startup of the power supply system 20; the reference power supply quantity indicates the power quantity which must be supplied to the thin-film heaters 24a, 25a, 26a while attaining the regulated startup temperature from initiation of the startup; the temperature change tolerance level at operation time indicates the tolerance level value of the temperature change at operation time of the power supply system 20; the reference power supply at operation time indicates the proper value of electric power supplied to each of the thin-film heaters at operation time; the fuel supply quantity tolerance level indicates the tolerance level variation of the fuel injection quantity of fuel for power generation at operation time; the power supply tolerance level at operation time indicates the tolerance level variation of the electric power supplied to each of the thin-film heaters at operation time; and the like are memorized.

In addition, the power generation control section 22 executes an abnormal detection process at startup time and an abnormal detection process at operation time described later. Thus, by execution of an abnormal detection process at startup time, the power generation control section 22 detects whether or not abnormalities of damage (thermal insulation damage) to the thermal insulation container 29 at startup time of the fuel cell 27 and the like are occurring. Also, by execution of an abnormal detection process at operation time, the power generation control section 22 detects whether or not abnormalities by thermal insulation damage and the like in the thermal insulation container 29 occurred during power generation of the fuel cell 27. This will be explained later in detail.

<<Abnormal Detection Process at Startup Time>>

Next, the operation of the abnormal detection process at startup time in the power supply system 20 will be explained.

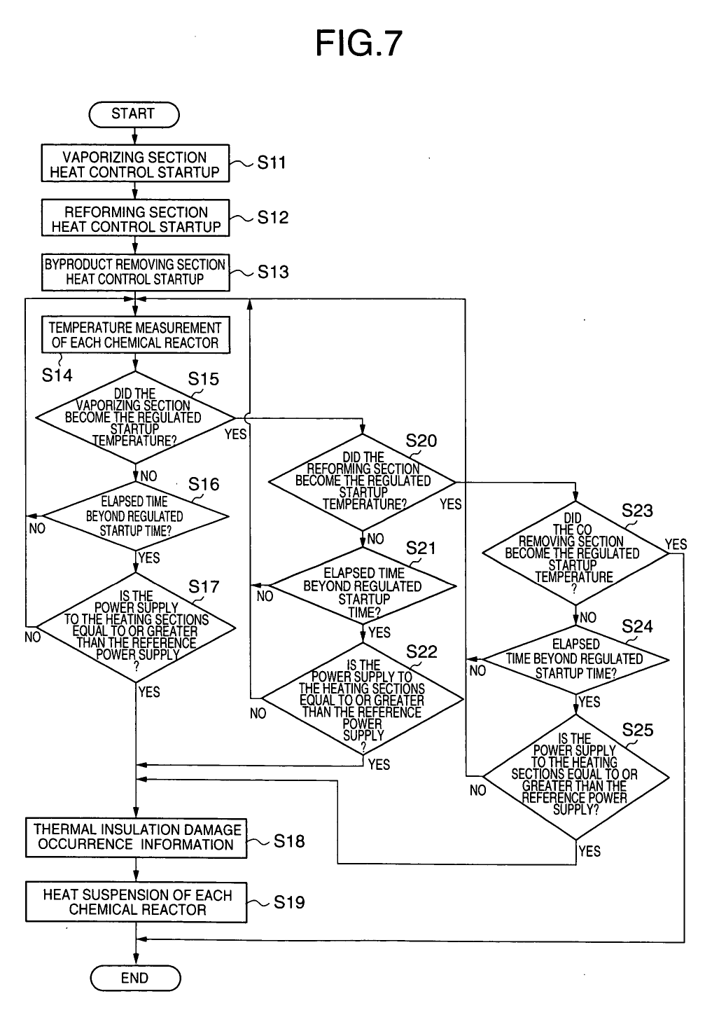

FIG. 7 is a flowchart which shows the operation of the abnormal detection process at startup time of the power supply system.

The abnormal detection process at startup time is a process performed at startup time by the power supply system 20, accompanying the startup of the electronic device 10, of the thermal insulation container 29 of the chemical reaction section 50. For example, it is a process for detecting whether or not abnormalities by thermal insulation damage and the like are occurring, such as when the thermal insulation structure is damaged from some impact and the like causing a loss of the vacuum inside the container.

The abnormal detection process at startup time, as shown in FIG. 7, the power generation control section 22 executes the abnormal detection process at startup time triggered by the operation startup from the power supply “ON” operation of the electronic device 10 being initiated (i.e. the device is switched “ON”). With the execution initiated the timer 34 times the elapsed time from the commencement time at operation startup.

Consequently, the power generation control section 22 initiates heat control by the thin-film heater 24a of the vaporizing section 24 via the driver 24b (Step S11). Secondly, the power generation control section 22 initiates heat control by the thin-film heater 25a of the reforming section 25 via the driver 25b (Step S12). Thirdly, the power generation control section 22 initiates heat control by the thin-film heater 26a of the byproduct removing section 26 via the driver 26b (Step S13). Next, the power generation control section 22 inputs the temperature measurement signal in response to the temperature detection signal of the temperature sensors 24c, 25c, 26c from the temperature detection section 28 and acquires the temperature measurement (the temperature reading) of each chemical reactor of the vaporizing section 24, the reforming section 25 and the byproduct removing section 26 as temperature at startup time (Step S14).

Subsequently, the power generation control section 22 reads the regulated startup temperature of the vaporizing section 24 from the ROM 22b and discriminates whether or not the temperature at startup time of the vaporizing section 24 is more than the regulated startup temperature acquired at Step S14 (Step S15).

When the temperature at startup time of the vaporizing section 24 is not more than the regulated startup temperature (Step S15: NO), the power generation control section 22 reads the regulated startup time corresponding to the vaporizing section 24 from the ROM 22b and acquires the current elapsed time from the timer 34. Also, the power generation control section 22 discriminates whether or not the acquired elapsed time became more than the regulated startup time (Step S16).

When the elapsed time is less than the regulated startup time (Step S16; NO), the power generation control section 22 reverts to Step S14.

When the elapsed time is equal to or greater than the regulated startup time (Step S16; YES), the power generation control section 22 calculates the power quantity (power supply quantity at startup time) supplied to the thin-film heater 24a from the commencement time at operation startup and reads the reference power supply quantity of the thin-film heater 24a from the ROM 22b. Also, the power generation control section 22 discriminates whether or not the power quantity supplied to the thin-film heater 24a is more than the quantity of the reference power supply (Step S17).

When the power quantity supplied to the thin-film heater 24a is not more than the reference power supply quantity (Step S17; NO), the power generation control section 22 reverts to Step S14.

This Step S17 discriminates whether or not the power quantity supplied to the thin-film heater is more than the reference power supply quantity when there is less power quantity supplied to the thin-film heater by some cause than the reference power supply quantity, and when the temperature reading of each section at the time expiration of the regulated startup time is lower than the preset temperature. A temperature decline is not that which is produced by thermal insulation damage of the thermal insulation container 29, but a possibility that the power quantity supplied to the thin-film heater generated which is judged high according to a few amassed factors as it performs more accurate detection of the existence of thermal insulation damage. In addition, in order to simplify control, discrimination in this Step S17 can be omitted.

When the power quantity supplied to the thin-film heater 24a is more than the reference power supply quantity (Step S17; YES), the power generation control section 22 judges high the possibility of abnormalities by thermal insulation damage in the thermal insulation container 29 and the like occurred; transmits a command signal “possibility of thermal insulation damage occurred is high” to the CPU 11; and further outputs a command signal “possibility of thermal insulation damage occurred is high” to the information section 33 (Step S18).

In other words, abnormal detection at startup time, for example, when abnormalities produce some damage in the thermal insulation container 29 and thermal insulation structure damages occur, ambient air penetrates from the damaged section, the thermal insulation function deteriorates and heat leakage increases. The state based among others where the predetermined electric power is supplied to the thin-film heaters, a phenomenon in which the temperature of each chemical reactor will not increase to a set value occurs. When a phenomenon in which the temperature of each chemical reactor does not attain a set value is detected, it judges with the possibility that thermal insulation damage has occurred as being high.

The information section 33 reports a command “possibility that thermal insulation same occurred is high” to the user via audio, a screen display, optical and the like. Also, the power generation control section 22 outputs a temperature control signal to the drivers 24b, 25b, 26b so that the feed of the electric power to the thin-film heaters 24a, 25a 26a can be suspended, suspends heating of each chemical reactor and suspends the operation (Step S19). Thereby, the abnormal detection process is terminated at startup time.

Next, when the temperature reading of the vaporizing section 24 is more than the preset temperature (Step S15; YES), the power generation control section 22 reads the regulated startup temperature of the reforming section 25 from ROM 22b and discriminates whether or not the temperature at startup time is more than the regulated startup temperature of the reforming section 25 acquired at Step S14 (Step S20).

When the temperature at startup time of the reforming section 25 is not more than the regulated startup temperature (Step S20; NO), the power generation control section 22 reads the regulated startup time in relation to the reforming section 25 from ROM 22b and acquires the current elapsed time from the timer 34.

Also, the power generation control section 22 discriminates whether or not the acquired elapsed time exceeds (continues beyond) the regulated startup time (Step S21). When the elapsed time does not exceed the regulated startup time (Step S21; NO), the power generation control section 22 reverts to Step S14.

When the elapsed time is equal to or exceeds (greater than) the regulated startup time (Step S21; YES), the power generation control section 22 calculates the power quantity (power supply quantity at startup time) supplied to the thin-film heater 25a from the commencement time at operation startup and reads the reference power supply quantity of the thin-film heater 25a from ROM 22b.

Additionally, the power generation control section 22 discriminates whether or not the power quantity supplied to the thin-film heater 25a is more than the reference power supply quantity (Step S22). When the power quantity supplied to the thin-film heater 25a is not more than the reference power supply quantity (Step S22; NO), the power generation control section 22 reverts to Step S14.

When the power quantity supplied to the thin-film heater 25a is more than the reference power supply quantity (Step S22; YES), the power generation control section 22 judges high the possibility that abnormalities by thermal insulation damage in the thermal insulation container 29 and the like occurred, and progresses to Steps S18 and S19.

Next, when the temperature reading of the reforming section 25 is more than the preset temperature (Step S20; YES), the power generation control section 22 reads the regulated startup temperature of the byproduct removing section 26 from ROM 22b and discriminates whether or not the temperature at startup time of the byproduct removing section 26 acquired at Step S14 is more than the regulated startup temperature (Step S23).

Similarly, when the temperature at startup time of the byproduct removing section 26 is not more than the regulated startup temperature (Step S23; NO), the power generation control section reads the regulated startup time in relation to the byproduct removing section 26 from ROM 22b and acquires the current elapsed time from the timer 34. Also, the power generation control section 22 discriminates whether or not the acquired elapsed time exceeds (continues beyond) the regulated startup time (Step S24). When the elapsed time does not exceed the regulated startup time, the power generation control section 22 reverts to Step S14.

When the elapsed time is equal to or exceeds (greater than) the regulated startup time (Step S24; YES), the power generation control section 22 calculates the power quantity (power supply quantity at startup time) supplied to the thin-film heater 26a from the commencement time of the startup operation and reads the reference power supply quantity of the thin-film heater 26a from ROM 22b. Also, the power generation control section 22 discriminates whether or not the power quantity currently supplied to the thin-film heater 26a is more than the reference power supply quantity (Step S25). When the power quantity currently supplied to the thin-film heater 26a is not more than the reference power supply quantity (Step S25; NO), the power generation control section 22 reverts to Step S14. When the power quantity supplied to the thin-film heater 26a is more than the reference power supply quantity (Step S25; YES), the power generation control section 22 judges high the possibility of abnormalities by thermal insulation damage in the thermal insulation container 29 and the like occurred, and progresses to Steps S18 and S19.

Furthermore, when the temperature reading of the byproduct removing section 26 is more than the preset temperature (Step S23; YES), the power generation control section 22 judges as a normal abnormality in the thermal insulation container 29 and the abnormal detection process is terminated at startup time.

<<Abnormal Detection Process at Operation Time>>

Next, the operation of the abnormal detection process at operation time in the power supply system 20 will be explained.

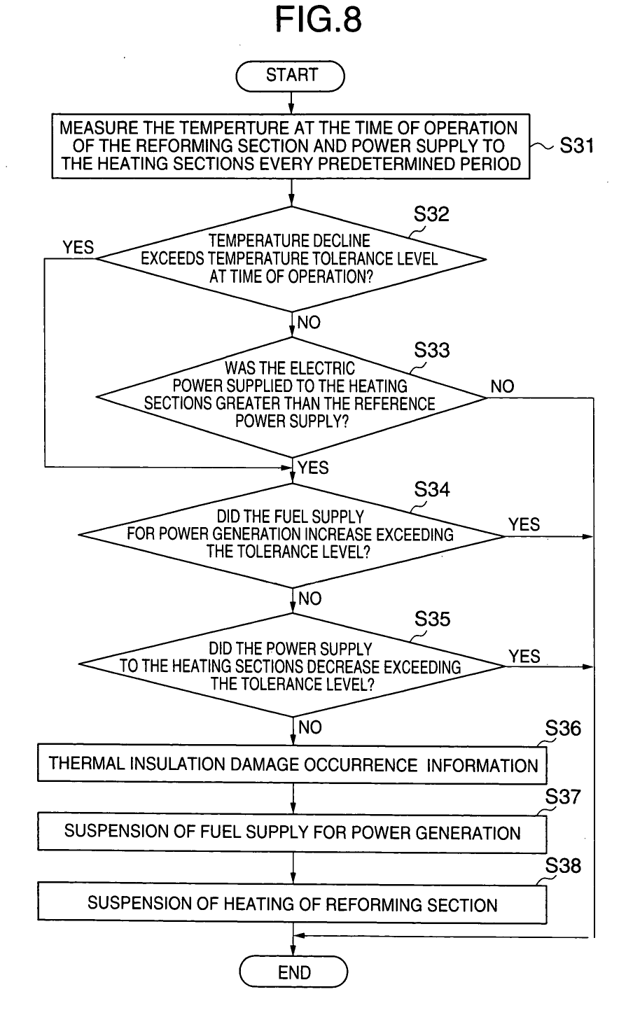

FIG. 8 is a flowchart which shows operation of the abnormal detection process at operation time of the power supply system.

The abnormal detection process at operation time is performed continuously (ongoing) by the power generation operation by the power supply system 20; performed when in a balanced operating state; performed repeatedly at predetermined time intervals; and set during activity of the electronic device 10. The abnormal detection process is for detecting occurrence of abnormalities by thermal insulation damage and the like of the thermal insulation container 29 in the chemical reaction section 50.

Here, in the abnormal detection process at operation time illustrated below to perform the abnormal detection process is focused only on the reforming section 25 of a plurality of chemical reactors of the chemical reaction section 50 at operation time. This is because the structure of the reforming section 25 has a temperature level higher than the vaporizing section 24 and the byproduct removing section 26 and the greatest influence tends to be observed in the temperature change when abnormalities by thermal insulation damage of the thermal insulation container 29 occurred. However, the present invention is not limited to this as besides the reforming section 25 the configuration is also designed to check (examine) both sides of either the vaporizing section 24 or the byproduct removing section 26. In this case, even minor damage can be detected more quickly.

In the abnormal detection process at the time of operation, the power generation control section 22 as shown in FIG. 8, first the process continues in a period set previously for every predetermined time interval; inputs the temperature measurement signal in relation to the temperature detection signal from the temperature sensor 25c from the temperature detection section 28; and acquires the current temperature of the reforming section 25 as the temperature at operation time.

The power generation control section 22 measures the current power supply supplied to the thin-film heater 25a for every predetermined time interval (power supply measurement portion). Also, the power generation control section 22 calculates the fuel supply quantity supplied for power generation supplied to the power generation section 60 based on the variation of the residual quantity obtained from the residual quantity sensor 21b (fuel supply quantity detection portion). In addition, the power generation control section 22 instructs RAM 22a to memorize the temperature value at operation startup of the reforming section 25; the power supply value currently supplied to the thin-film heater 25a; and the fuel supply quantity value for power generation (Step S31).

Subsequently, the power generation control section 22 reads the value of the temperature change tolerance level at operation time of the reforming section 25 from ROM 22b; compares the temperature change of every predetermined time interval and the temperature change tolerance level at operation time with the temperature at operation time of the reforming section 25 acquired in Step S31; and discriminates whether or not a rapid decline exceeds the temperature tolerance level at operation time occurred, that is to say, whether or not the temperature change at operation time and the quantity of temperature decline is greater than the value of the temperature change tolerance limit level at operation time (Step S32).

Also, when a phenomenon in which a rapid decline in temperature at operation time occurred (Step S32; YES), the power generation control section 22 progresses to Step S34.

On the other hand, when a phenomenon in which a rapid decline in the temperature at operation time of the reforming section 25 does not occur (Step S32; NO), the power generation control section 22 discriminates whether or not the previous electric power supplied to the thin-film heater 25a acquired in Step S31 is appropriate (Step S33). Specifically, the power generation control section 22 reads the reference power supply at the time of operation memorized previously by ROM 22b and discriminates whether or not the electric power supplied to the thin-film heater 25a in the period which acquires the temperature at operation time is greater than the reference power at operation time. This, in the power supply system 20, for example, corresponding to the state of power supplied to the electronic device 10 (load) from the power supply system 20, when the power supplied to the thin-film heater is equipped with a configuration controlled automatically, even if it is the cases of abnormalities by thermal insulation damage and the like of the thermal insulation container 29 occurred and a phenomenon in which the temperature of a chemical reactor and the electric power generation declines temporarily occurred, it can be controlled to cover the portion of the temperature decline by increasing automatically the power supplied to the thin-film heaters. Seemingly the situation is controlled so that the rapid temperature decline does not occur. In this case, occurrence of abnormalities can be detected only by supervising the presence of the rapid decline of the temperature at operation time. Then, add discrimination of whether or not there is any great increase in the power supplied to the thin-film heater and get rid of the leakage in detection of abnormalities in the thermal installation and the like.

Then, when the power supplied to the thin-film heater 25a is not more than the reference power supply at operation time (Step S33; NO), the power generation control section 22 performs an abnormal detection process termination at operation time as having no abnormalities.

When the power supplied to the thin-film heater 25a is more than the reference power supply at operation time (Step S33; YES), the power generation control section 22 progresses to Step S34.

Thus, a phenomenon when the temperature measurement of the reforming section 25 rapidly declines or a phenomenon in which the power to the thin-film heater 25a supplied is greater than the proper value and on the other side tries to check (examine) whether or not in addition to thermal insulation damage of the thermal insulation container 29 to judge the probability that some abnormalities are occurring and the cause of the abnormality.

Next, in Step S34, the power generation control section 22 discriminates whether or not the rapid increase that occurred exceeds the tolerance level of fuel injection quantity directly before detecting the above-mentioned abnormalities by reading the fuel injection quantity for every predetermined time interval memorized by RAM 22a. Specifically, the power generation control section 22 reads the fuel supply quantity tolerance level which shows the variation tolerance level of the fuel supply quantity at operation time memorized previously by ROM 22b and discriminates whether or not the variation quantity of the fuel injection quantity is greater than the fuel supply quantity tolerance level. Also, when a rapid increase occurs which exceeds the fuel supply quantity tolerance level of the fuel supply quantity of fuel for power generation (Step S34; YES), the power generation control section 22 performs the abnormal detection process termination at operation time as having no abnormalities. This is because it is judged that the increase of power supplied to the thin-film heater 25a corresponding to the rapid decline or this temperature change from a present temperature to the temperature of the reforming section 25 which is an endothermic reaction occurred when the fuel injection quantity of fuel for power generation rapidly increased.

Next, when a phenomenon in which the fuel supply quantity of fuel for power generation rapidly increases did not occur (Step S34; NO), the power generation control section 22 discriminates whether or not the rapid decline that occurred exceeds the tolerance level directly before detecting the above-mentioned abnormalities and reads the power supplied to the thin-film heater 25a for every predetermined time interval memorized by RAM 22a (Step S35). Specifically, the power generation control section 22 reads the power supply tolerance level at operation time which shows the variation tolerance level of the power supplied to the thin-film heater 25a at operation time memorized previously by ROM 22b and discriminates whether or not the variation quantity of the power supply is greater than the power supply tolerance level at operation time.

Additionally, when a rapid decrease occurs whereby the power supply tolerance level exceeds the power supplied to the thin-film heater 25a at operation time (Step S35; YES), the power generation control section 22 performs the abnormal detection process termination at operation time. This is because it is judged that the increase in the power supplied to the thin-film heater 25a corresponding to the rapid decline or this temperature change from a preset temperature of the reforming section 25 occurred when the power supplied to the thin-film heater 25a rapidly decreased.

When a phenomenon in which the power supplied to the thin-film heater 25a rapidly decreases (Step S35; NO), the power generation control section 22 judges abnormalities by thermal insulation damage and the like of the thermal insulation container 29 have occurred; transmits a command signal “possibility of thermal insulation damage occurred is high” to the CPU 11 and further outputted to the information section 33 (Step S36).

Accordingly, the judgment of an abnormal occurrence at operation time when the power generation operation by the power supply system 20 is performed, for example, once abnormalities in the thermal insulation damage and the like in the thermal insulation container 29 have occurred ambient air rapidly enters from the damage section; thermal insulation function rapidly declines; leakage of heat rapidly increases; temperature control is not suitable; temperature rapidly declines or a phenomenon in which the power supplied to the thin-film heater rapidly increases by the temperature control in response to the rapid decline of the temperature will occur. Then, when such a phenomenon is detected and there is a rapid increase of the fuel injection quantity or rapid decrease of the power supply to the thin-film heater, when no different dominant cause exists for thermal insulation damage it judges with the possibility that thermal insulation damage occurred is high.

Next, the information section 33 reports a command “possibility of thermal insulation damage occurred is high” to the user via audio, a screen display, optical and the like.

Additionally, the power generation control section 22 outputs a fuel supply control signal to the pump 23 so that feed of the fuel for power generation is suspended (Step S37); a temperature control signal is output to the drivers 24b, 25b, 26b so that power feed to the thin-film heaters 24a, 25a, 26a can be suspended (Step S38); and performs the abnormal detection process at operation time.

As mentioned above, according to the embodiment, at startup time of the power supply system 20 and each of the chemical reactors of the vaporizing section 24, the reforming section 25 and the byproduct removing section 26 of the power generation section 60, the presence of occurrences of abnormalities by thermal insulation damage and the like in the thermal insulation container 29 can be detected when reference power supply to the thin-film heater is supplied and the elapsed time from commencement of startup becomes the regulated startup time, based on discrimination of whether or not the temperature of each section becomes more than the preset temperature.

Additionally, according to the invention, occurrences of abnormalities by thermal insulation damage and the like of the thermal insulation container 29 are detectable by discrimination as it discriminates whether or not a rapid temperature decline from the preset temperature in the reforming section 25 occurred during the power generation operation of the power supply system 20; whether or not the fuel supply quantity rapidly increased when the temperature rapidly declined occurred; and whether or not the power supplied to the thin-film heater 25a rapidly declined. Furthermore, abnormalities by thermal insulation damage and the like of the thermal insulation container 29 can be detected by discrimination when a rapid temperature decline from the preset temperature does not occur in the reforming section 25, it discriminates whether or not the power supplied to the thin-film heater 25a is more than the reference power supply; whether or not the fuel supply quantity rapidly increased when the power supplied becomes more than the reference power supply; and whether or not the power supplied to the thin-film heater 25a rapidly declined.

Additionally, thermal insulation damage to the thermal insulation container 29 from the information section 33 can report a command notification to the user that the possibility of occurrence is high.

By these, as according to the embodiment, without merely using this detector for exclusive purpose as a vacuum sensor or an atmospheric pressure sensor and the like, with execution of the abnormal detection process at startup time and operation time abnormality of the power supply system by thermal insulation damage and the like can be detected simply, together with the power supply system can be miniaturized and the cost can be reduced.

<<The Second Embodiment of the Power Supply System>>

Next, the second embodiment of the power supply system related to this invention will be explained.

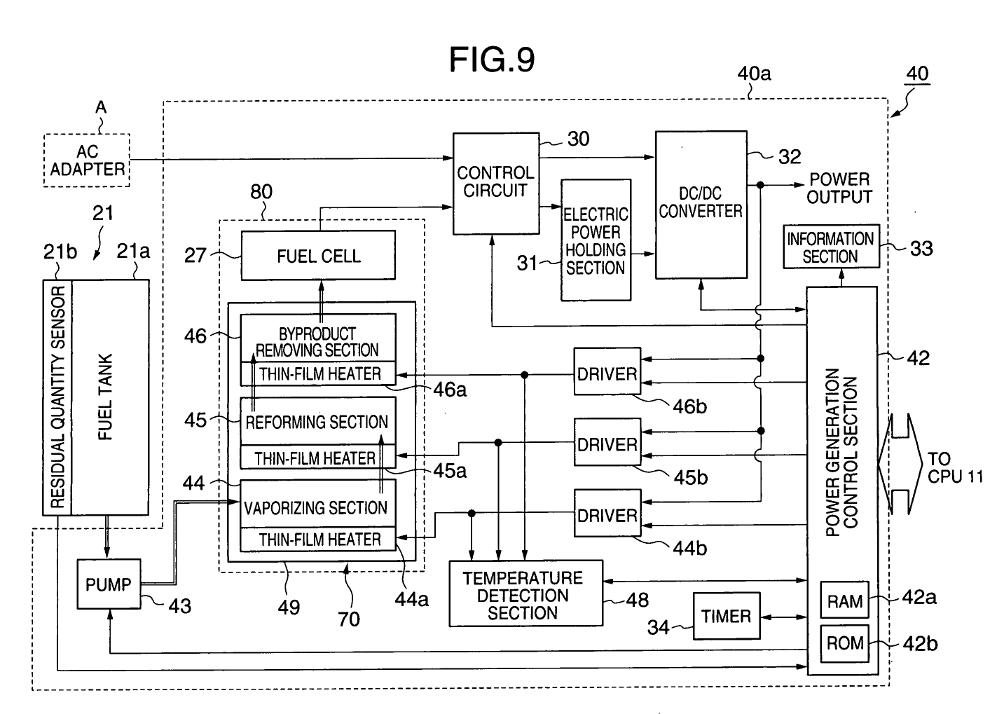

FIG. 9 is a block diagram showing the second embodiment of the power supply system related to the invention.

Here, the equivalent nomenclature correlated to the composition of the power supply system 20 of the first embodiment mentioned above is attached to simplify or omit from the description and explain mainly different sections.

The power supply system 40 related to this embodiment, as shown in FIG. 9, comprises divided sections equipped with the fuel cartridge 21 and a power generation module 40a. The fuel cartridge 21 is detachable. The power generation module 40a generates predetermined electric power (electrical energy) based on the fuel for power generation supplied from the fuel cartridge 21.

The power generation module 40a concerning this embodiment, as shown in FIG. 9, comprises a pump 43 which performs delivery or stoppage of the fuel for power generation supplied from the fuel cartridge 21; a plurality of chemical reactors includes a vaporizing section 44, a reforming section 45 and a byproduct removing section 46; the thin-film heaters 44a, 45a, 46a provided in each chemical reactor; a thermal insulation container 49; along with comprising a power generation section 80 which has a chemical reaction section 70 and a fuel cell 27; the drivers 44b, 45b, 46b which supply power for driving the thin-film heaters 44a, 45a, 46a using a portion of the power generated by the power generation section 80; and a temperature detection section 48. Furthermore, a power generation control section comprises RAM 42a and ROM 42b.

In this embodiment, the thin-film heaters 44a, 45a, 46a not only heat the vaporizing section 44, the reforming section 45 and byproduct removing section 46 respectively, but also are utilized for detection of the temperature of each section.

Detection of this temperature is performed by measuring the voltage in relation to the current for heating of each thin-film heater supplied to the thin-film heaters 44a, 45a, 46a from the drivers 44b, 45b, 46b in the temperature detection section 48; outputs the result to a power generation control section 42. The power generation control section 42 calculates the resistance value of each thin-film heater from the same measurement value and calculates the temperature corresponding to that resistance. Accordingly, the number of wires which penetrate the thermal insulation container 49 from each chemical reactor can be reduced; heat leaks via the wiring from the thermal insulation container 49 can be suppressed; heat efficiency can be elevated; as well as the cost can be reduced as temperature sensors are not used.

Next, the abnormal detection process at startup time in this power supply system 40 is essentially the same as the abnormal detection process at startup time of the power supply system 20 in FIG. 7. In this second embodiment, measurement of the temperature in Step S14 of FIG. 7 is performed using the thin-film heaters 44a, 45a, 46a.

Furthermore, the abnormal detection process operation time in the power supply system 40 is essentially the same as the abnormal detection process at operation time of the power supply system 20 in FIG. 8.

As mentioned above, also in the second embodiment, execution of the abnormal detection process at startup time and operation time is the same as the first embodiment above. Abnormality of the power supply system by thermal insulation damage and the like can be detected simply, without merely using this invention as a vacuum sensor or an atmospheric pressure sensor and the like; and further, the cost can be reduced as heat efficiency can be elevated by performing the temperature detection using the thin-film heaters.

Moreover, in the first embodiment and the second embodiment, the thermal insulation container encloses the entire configuration equipped with the thin-film heaters provided in each chemical reactor and each chemical reactor which includes the vaporizing section, the reforming section and the byproduct removing section, and although the configuration is formed as unit in one body, this invention is not limited to this. For example, a configuration in which the thermal insulation container is separately formed in each vaporizing section and its thin-film heater, the reforming section and its thin-film heater, and the byproduct removing section and its thin-film heater may be suitable. As for this configuration separately formed, in the abnormal detection process, it becomes a configuration which performs separate checks (examinations) of the vaporizing section, the reforming section and the byproduct removing section respectively at operation time.

Besides, in the description of each embodiment mentioned above, although the execution of the abnormal detection process at startup time and operation time is presupposed that it detects damage by thermal insulation damage of the thermal insulation container in the chemical reaction section of the power generation section have occurred and performs detection of the abnormality of the power supply system based on the temperature of the chemical reactors, the abnormal detection process is not limited to thermal insulation damage of the thermal insulation container. In short, the state of abnormality of where heat in the chemical reaction leaks to the outside occurred based on which particular section is damaged and the like.

Furthermore, in the first embodiment and second embodiment, although a thin-film heater performs heating of each chemical reactor, this invention is not limited to this as it can be adapted for use as a catalytic combustion device in addition to a thin-film heater.

Also, the first embodiment can be adapted for use only as a catalytic combustion device by substituting the thin-film heaters.

Lastly, in the first embodiment and second embodiment, when the information section is formed in the power supply system and there are abnormalities by thermal insulation damage and the like the system reports a command that abnormalities have occurred, but this invention is not limited to this. For example, a configuration in which the information section is not formed in the power supply system, but comprises some other information portion or electronic device screen display; and when there are abnormalities by thermal insulation damage and the like which transmits a command signal that abnormalities have occurred from the power supply system to the CPU, a configuration in which the command of abnormal occurrence can be reported to some other information portion or electronic device screen display from the CPU side.

While the present invention has been described with reference to the preferred embodiments, it is intended that the invention be not limited by any of the details of the description thereof.

As this invention can be embodied in several forms without departing from the spirit of the essential characteristics thereof, the present embodiments are therefore illustrative and not restrictive, since the scope of the invention is defined by the appended claims rather than by the description preceding them, and all changes that fall within meets and bounds of the claims, or equivalence of such meets and bounds thereof are intended to be embraced by the claims.

1. A power supply system for producing electric power comprising:
a power generation section which generates the electric power comprising:
at least one chemical reaction section to which the fuel for power generation is supplied and
the heating sections which heat the chemical reaction section;
a temperature detection section which detects the temperature of the chemical reaction section; and
a power generation control section comprising an abnormal judgment portion which judges whether or not abnormalities in the power supply system are occurring at least based on the temperature of the chemical reaction section detected by the temperature detection section.

2. The power supply system according to claim 1, wherein the power generation control section further comprises a temperature change detection portion which detects the temporal response of the temperature of the chemical reaction section based on detection of the temperature of the chemical reaction section by the temperature detection section.

3. The power supply system according to claim 2, wherein the power generation control section comprises a temperature change discrimination portion which determines whether or not the temperature change detected by the temperature change detection portion is the proper variation quantity.

4. The power supply system according to claim 3, wherein the abnormal judgment portion judges abnormalities in the power supply system are occurring when the quantity of temperature change is determined as not the proper variation quantity by the temperature change discrimination portion.

5. The power supply system according to claim 3, wherein the proper variation quantity in the temperature change discrimination portion is the quantity of temperature change according to the heating state of the chemical reaction section by the heating sections in the chemical reaction section.

6. The power supply system according to claim 3, wherein the proper variation quantity in the temperature discrimination portion is the quantity of the temperature change of temperature change according to the heating state of the chemical reaction section by the heating sections in the chemical reaction section and the supply state of the fuel for power generation in the chemical reaction section.

7. The power supply system according to claim 1, wherein the chemical reaction section comprises a thermal insulation container which isolates at least the heating sections from ambient air.

8. The power supply system according to claim 7, wherein a space is formed in between the inner wall surface of the thermal insulation container and at least the heating sections;
within the space is a substantially vacuum state and is any state of the gas enclosed whose heat conductivity is lower than the structure components of the thermal insulation container.

9. The power supply system according to claim 1, wherein the power generation section comprises a fuel cell which generates the electric power by electrochemical reaction using a specified fuel element including hydrogen fuel for power generation.

10. The power supply system according to claim 9, wherein the chemical reaction section comprises at least a plurality of chemical reactors which includes a fuel vaporizing section which vaporizes the fuel for power generation; and
a fuel reforming section which produces the specified fuel element from the vaporized fuel for power generation.

11. The power supply system according to claim 10, wherein the chemical reaction section further comprises a byproduct removing section which removes the byproduct generated by the catalytic reaction in the fuel reforming section.

12. The power supply system according to claim 10, wherein each of a plurality of chemical reactors in the chemical reaction section comprises a thermal insulation container for isolating at least the heating sections from ambient air.

13. The power supply system according to claim 12, wherein a space is formed in between the inner wall surface of the thermal insulation container and at least the heating sections;
within the space is a substantially vacuum state and is any state of the gas enclosed whose heat conductivity is lower than the structure components of the thermal insulation container.

14. The power supply system according to claim 10, wherein the temperature detection section comprises a portion which detects the respective temperature of a plurality of chemical reactors in the chemical reaction section.

15. The power supply system according to claim 14, wherein the portion which detects said temperature in the temperature detection section has the temperature sensors provided in each of a plurality of chemical reactors in the chemical reaction section.

16. The power supply system according to claim 10, wherein the heating sections comprise a portion which heats a plurality of chemical reactors in the chemical reaction section.

17. The power supply system according to claim 16, wherein the heating sections comprises the heaters provided in each of a plurality of chemical reactors in the chemical reaction section; and
the temperature detection section uses the heaters and detects temperature based on the variation according to the temperature of the electric resistance value of these heaters.

18. The power supply system according to claim 1, wherein the chemical reaction section comprises:
at least a plurality of substrates joined to each other; and
at least one passage provided in at least one surface in a plurality of substrates to which the fuel for power generation is supplied; and
the heating sections provided in at least one surface of at least one substrate in a plurality of substrates and comprise a portion which heats the passage.

19. The power supply system according to claim 18, wherein a reaction catalyst layer is formed in at least a portion of the passage.

20. The power supply system according to claim 18, wherein the heating sections comprise the heaters provided in at least one surface of the substrate.

21. The power supply system according to claim 20, wherein the heaters have a shape corresponding to the flat surface shape of the passage.

22. The power supply system according to claim 1, wherein the power generation control section comprises a timer which times the heating elapsed time from the heating startup time of the chemical reaction section by the heating sections.

23. The power supply system according to claim 22, wherein the power generation control section comprises a portion which detects the temperature of the chemical reaction section at startup time when the heating elapsed time of the timer becomes the predetermined regulated startup time by the temperature detection section.

24. The power supply system according to claim 23, wherein the power generation control section comprises a temperature change discrimination portion which discriminates the relative difference by comparing the temperature at startup time with the predetermined regulated startup temperature.

25. The power supply system according to claim 24, wherein the abnormal judgment portion judges abnormalities in the power supply system are occurring when the temperature at startup time is discriminated as lower than the regulated startup temperature by the temperature change discrimination portion.

26. The power supply system according to claim 22, wherein the power generation control section comprises a power supply measurement portion which measures the power supply supplied to the heating sections.

27. The power supply system according to claim 26, wherein the power generation control section comprises a portion which measures the power supply quantity supplied to the heating sections as the power supply quantity at startup time when the heating elapsed time according to the timer becomes the predetermined regulated startup time by the power supply measurement portion.

28. The power supply system according to claim 27, wherein the power generation control section comprises:
a temperature change discrimination portion which discriminates relative difference by comparing the temperature at startup time with the predetermined regulated startup temperature; and
a power supply quantity discrimination portion which discriminates relative difference by comparing the power supply quantity at startup time with the reference power supply quantity supplied to the heating sections.

29. The power supply system according to claim 28, wherein:
the abnormal judgment portion judges abnormalities are occurring in the power supply system when the temperature is discriminated at startup time as lower than the regulated startup temperature by the temperature change discrimination portion, and the power supply quantity at startup time is discriminated as equal to or greater than the reference power supply quantity by the power supply quantity discrimination portion.

30. The power supply system according to claim 1, wherein the power generation control section comprises a portion which detects the temporal response of the temperature of the chemical reaction section as a temperature change at operation time, based on detection of the temperature of the chemical reaction section by the temperature detection section at operation time of the power generation section.

31. The power supply system according to claim 30, wherein the power generation control section comprises a temperature change discrimination portion which discriminates whether or not the temperature change tolerance level at that operation time deviated by comparing the temperature change at operation time with the temperature change tolerance level at predetermined operation time.

32. The power supply system according to claim 31, wherein the abnormal judgment portion judges whether or not abnormalities in the power supply system are occurring based on the discrimination result of whether or not the temperature change at that operation time deviated from the temperature change tolerance level at operation time by the temperature change discrimination portion.

33. The power supply system according to claim 31, wherein the power generation control section comprises:
a fuel supply quantity detection portion which detects the fuel supply quantity for the power generation supplied to the power generation section; and
a power supply measurement portion which measures the power supply supplied to the heating sections.

34. The power supply system according to claim 33, wherein the power generation control section comprises:
a fuel supply quantity discrimination portion which discriminates whether or not the fuel supply tolerance level deviated by comparing the supplied fuel quantity for power generation with the predetermined fuel supply quantity tolerance level detected by the fuel supply quantity detection portion; and
a power supply discrimination portion which discriminates whether or not the power supply tolerance level at that operation time deviated by comparing the power supply measured by the power supply measurement portion with the power supply tolerance level at predetermined operation time.

35. The power supply system according to claim 34, wherein the abnormal judgment portion judges abnormalities in the power supply system are occurring when the power supply is discriminated as within the power supply tolerance level at operation time by the power supply discrimination portion; the fuel supply for the power generation is discriminated as within the fuel supply quantity tolerance level by the fuel supply quantity discrimination portion; and the temperature change at operation time is discriminated as deviated from the temperature change tolerance level in the temperature decline direction at operation time by the temperature change discrimination portion.

36. The power supply system according to claim 34, wherein the power generation control section further comprises a portion which compares the power supply with the reference power supply at operation time supplied to the heating sections while detecting the temperature change at operation time; and
the abnormal judgment portion judges abnormalities are occurring in the power supply system when the temperature change at operation time is within the temperature change tolerance level by the temperature change discrimination portion; the power supply supplied to the heating sections at the time of temperature change detection at operation time is discriminated as exceeded the reference power supply at operation time; the fuel supply for the power generation is discriminated as within the fuel supply quantity tolerance level by the fuel supply quantity discrimination portion; and the power supply is discriminated as within the power supply tolerance level by the power supply discrimination portion.

37. The power supply system according to claim 1, comprises an information section which performs predetermined information when abnormalities in the power supply system are occurring by judgment of the abnormal judgment portion.

38. The power supply system according to claim 37, wherein the information section comprises at least any display portion, audio output portion and oscillating generations portion.

39. The power supply system according to claim 1, wherein the power generation control section comprises a portion which suspends heating of the chemical reaction section by the heating sections when abnormalities in the power supply system are occurring by judgment of the abnormal judgment portion.

40. The power supply system according to claim 1, comprises a fuel supply section for power generation which supplies the fuel for power generation to the chemical reaction section.

41. The power supply system according to claim 40, wherein the power generation control section comprises a portion which suspends the feed of fuel for power generation to the chemical reaction section by the fuel supply section when abnormalities in the power supply system are occurring by judgment of the abnormal judgment portion.

42. An abnormal detection method of a power supply system comprises least:
a power generation section for generating power comprises at least one chemical reaction section based on the feed of fuel for power generation to this chemical reaction section, includes:
a step for heating the chemical reaction section;
a step for detecting the temperature accompanying the heating of the chemical reaction section; and
a step for judging at least whether or not abnormalities in the power supply system are occurring based on the detected temperature of the chemical reaction section.

43. The abnormal detection method of a power supply system according to claim 42, includes a step which times the heating elapsed time from the heating start up time of the chemical reaction section.

44. The abnormal detection method of the power supply system according to claim 43, wherein the step which detects the temperature of the chemical reaction section includes:
a step which detects the temperature of the chemical reaction section as the temperature at startup time when the heating time elapsed time becomes the predetermined regulated startup time.

45. The abnormal detection method of the power supply system according to claim 44, wherein the step which judges whether or not abnormalities to the power supply system are occurring includes:
a step which compares the temperature at startup time with the predetermined regulated startup temperature; and
a step which judges abnormalities in the power supply system are occurring when the temperature at startup time is lower than the regulated startup temperature.

46. The abnormal detection method of the power supply system according to claim 44, wherein the power supply system comprises heating sections to which electric power is supplied and heats the chemical reaction section; and
the abnormal detection method of the power supply system includes a step which measures the power supply quantity supplied to the heating sections for heating of the chemical reaction section.

47. The abnormal detection method of the power supply system according to claim 46, wherein the step which measures the power supply quantity includes:
a step which measures the power supply quantity supplied by the time the heating elapsed time becomes the predetermined regulated startup time as the power supply quantity at startup time.

48. The abnormal detection method of the power supply system according to claim 47, wherein the step which judges whether or not abnormalities in the power supply system are occurring includes:
a step which compares the temperature at startup time with the predetermined regulated startup temperature;
a step which compares the power supply quantity at startup time with the predetermined reference power supply quantity; and
a step which judges abnormalities in the power supply system are occurring when the power supply quantity at startup time is equal to or greater than the reference power supply quantity, and the temperature at startup time is lower than the regulated startup temperature.

49. The abnormal detection method of the power supply system according to claim 42, includes a step which detects the temporal response of the temperature of the chemical reaction section as a temperature change at operation time based on detection of the temperature of the chemical reaction section during power generation operation of the power generation section.

50. The abnormal detection method of the power supply system according to claim 49, wherein the step which judges whether or not abnormalities in the power supply system are occurring includes:
a step which compares the temperature change at operation time of the operation with the temperature change tolerance level at predetermined operation time; and
a step which judges abnormalities in the power supply system are occurring when the temperature change at operation time deviated from the temperature change tolerance level at operation time.

51. The abnormal detection method of the power supply system according to claim 49, includes a step which detects the fuel supply for the power generation supplied to the chemical reaction section.

52. The abnormal detection method of the power supply system according to claim 51, wherein the power supply system comprises:
the heating sections which electric power is supplied and heats the chemical reaction section; and
the abnormal detection method of the power supply system includes a step which measures the power supply supplied to the heating sections for heating of the chemical reaction section.

53. The abnormal detection method of the power supply system according to claim 52, wherein the step which judges whether or not abnormalities in the power supply system are occurring includes:
a step which compares the temperature change at operation time with the temperature change tolerance level at operation time;
a step which discriminates whether or not the fuel supply tolerance level deviated by comparing the supplied fuel quantity for power generation with the predetermined fuel supply quantity tolerance level;
a step which discriminates whether or not the power supply tolerance level at that operation time deviated by comparing the power supply with the power supply tolerance level at predetermined operation time; and
a step which judges abnormalities in the power supply system are occurring when the temperature change at operation time is discriminated as deviated from the temperature change tolerance level in the temperature decline direction at operation time; the fuel supply for the power generation is discriminated as within the fuel supply quantity tolerance level; and the power supply is discriminated as within the power supply tolerance level at operation time.

54. The abnormal detection method of the power supply system according to claim 52, wherein the step which judges whether or not abnormalities in the power supply system are occurring includes:
a step which discriminates whether or not the power supplied for heating of the chemical reaction section at the time of temperature change detection at operation time is the proper value, and by comparing the temperature change at operation time with the temperature change tolerance level at predetermined operation time;
a step which discriminates whether or not the fuel supply quantity tolerance level at that operation time deviated by comparing the fuel supply for the power generation with the predetermined fuel supply quantity tolerance level;
a step which discriminates whether or not the power supply tolerance level at operation time deviated by comparing the power supply with the predetermined power supply tolerance level at operation time; and
a step which judges abnormalities in the power supply system are occurring when the temperature change at operation time occurred within the temperature change tolerance level at operation time; the power supply supplied for heating of the chemical reaction section at the time of temperature change at operation time is discriminated as exceeded the proper value; the power supply is discriminated as within the power supply tolerance level at operation time; and the fuel supply quantity for power generation is discriminated as within the fuel supply quantity tolerance level.

55. The abnormal detection method of the power supply system according to claim 42, wherein the abnormal detection method of the power supply system includes a step which performs predetermined information when judged abnormalities in the power supply system are occurring.

56. The abnormal detection method of the power supply system according to claim 42, wherein the abnormal detection method of the power supply system includes a step which suspends heating of the chemical reaction section when judged abnormalities to the power supply system are occurring.

57. The abnormal detection method of the power supply system according to claim 42, wherein the abnormal detection method of the power supply system includes a step which suspends the feed of fuel for the power generation to the chemical reaction section when judged abnormalities to the power supply system are occurring.
